(19) United States
(12) Patent Application Publication
(10) Pub. No.: US 2022/0216757 A1
(43) Pub. Date: Jul. 7, 2022

(54) STATOR, ELECTRIC MOTOR, COMPRESSOR, AIR CONDITIONER, METHOD FOR FABRICATING STATOR, AND MAGNETIZATION METHOD

(71) Applicant: Mitsubishi Electric Corporation, TOKYO (JP)

(72) Inventor: Atsushi MATSUOKA, Tokyo (JP)

(21) Appl. No.: 17/609,880

(22) PCT Filed: Jul. 12, 2019
(86) PCT No.: PCT/JP2019/027649

§ 371 Date: Nov. 9, 2021

(51) Int. Cl. H02K 3/28; H02K 1/16

(52) U.S. Cl. CPC H02K 3/28; H02K 1/16

(57) ABSTRACT

A stator includes: a stator core; three-phase coils attached to the stator core by distributed winding; and a lacing material. A first phase coil is a coil through which a largest current flows among the three-phase coils when a current flows through the three-phase coils from a source of electric power for magnetizing a magnetic material. The first phase coil has a first region, a second region, and a third region. The lacing material is wound on the first region more than at least one of the second region or the third region.

### CROSS REFERENCE TO RELATED APPLICATION

This application is a U.S. National Stage Application of International Application No. PCT/JP2019/027649, filed on Jul. 12, 2019, the contents of which are incorporated herein by reference.

### TECHNICAL FIELD

The present invention relates to a stator for an electric motor.

### BACKGROUND

There is generally known a magnetization method for magnetizing a magnetic material of a rotor by using three-phase coils attached to a stator core. In this magnetization method, when a current for magnetization flows through the three-phase coils, an electromagnetic force might occur to cause deformation of the three-phase coils. In view of this, in the stator of Patent Reference 1, to prevent deformation of the three-phase coils, a lacing material is equally wound on the three-phase coils circumferentially.

### PATENT REFERENCE

Patent Reference 1: Japanese Patent Application Publication No. H11-136896

In conventional techniques, however, a large amount of a lacing material is needed in magnetization in a state where a rotor is disposed inside a stator. Accordingly, costs for the stator increases, and significant deformation of three-phase coils of the stator cannot be prevented efficiently.

### SUMMARY

It is therefore an object of the present invention to efficiently prevent significant deformation of three-phase coils of a stator in magnetization performed in a state where a rotor is disposed inside the stator.

A stator according to one aspect of the present invention is a stator capable of magnetizing a magnetic material of a rotor, and includes: a stator core; three-phase coils attached to the stator core by distributed winding, the three-phase coils including a first phase coil, a second phase coil, and a third phase coil; and a lacing material wound on the three-phase coil, wherein the first phase coil is a coil through which a largest current flows among the three-phase coils when a current flows through the three-phase coils from a source of electric power for magnetizing the magnetic material, the first phase coil has a first region, a second region, and a third region that are divided equally in a coil end of the three-phase coils, the first region is located between the second region and the third region, and the lacing material is wound on the first region more than at least one of the second region or the third region.

A stator according to another aspect of the present invention includes: a stator capable of magnetizing a magnetic material of a rotor, and includes: a stator core; three-phase coils attached to the stator core by distributed winding and including a first phase coil, a second phase coil, and a third phase coil; and a lacing material wound on the three-phase coil, wherein when a current flows through the three-phase coils from the source of electric power for magnetizing the magnetic material, a current flowing through the first phase coil is larger than at least one of a current flowing through the second phase coil or a current flowing through the third phase coil, in the coil end of the three-phase coils, the third phase coils includes a first region, a second region, and a third region that are divided equally, the first region is located between the second region and the third region, the lacing material is wound on the first region more than at least one either the second region or the third region.

An electric motor according to another aspect of the present invention includes: the stator; and the rotor disposed inside the stator.

A compressor according to another aspect of the present invention includes: a closed container; a compression device disposed in the closed container; and the electric motor configured to drive the compression device.

An air conditioner according to another aspect of the present invention includes: the compressor; and a heat exchanger.

A method for fabricating a stator according to another aspect of the present invention is a method for fabricating a stator, the stator including a stator core and three-phase coils attached to the stator core by distributed winding, the three-phase coils including a first phase coil, a second phase coil, and a third phase coil, the first phase coil having a first region, a second region, and a third region that are divided equally in a coil end of the three-phase coils, the first region being located between the second region and the third region, and the method includes: attaching the three-phase coils to the stator core by distributed winding; and winding a lacing material on the first region more than at least one of the second region or the third region in a coil end of the first phase coil.

A magnetization method according to another aspect of the present invention is a method for magnetizing a magnetic material of a rotor inside a stator, the stator including a stator core and three-phase coils, the three-phase coils being attached to the stator core by distributed winding and including a first phase coil, a second phase coil, and a third phase coil, the first phase coil having a first region, a second region, and a third region that are divided equally in a coil end of the three-phase coil, the first region being located between the second region and the third region, a lacing material being wound on the first region more than at least one of the second region or the third region in a coil end of the first phase coil, and the method includes: disposing the rotor including the magnetic material inside the stator; and supplying a current to the three-phase coils from a source of electric power for magnetizing the magnetic material so that a largest current flows through the first phase coil.

According to the present invention, in magnetization performed in a state where a rotor is disposed inside a stator, significant deformation of three-phase coils of the stator can be prevented efficiently.

### BRIEF DESCRIPTION OF THE DRAWINGS

FIG. 1 is a plan view schematically illustrating a structure of an electric motor according to a first embodiment of the present invention.

FIG. 2 is a plan view schematically illustrating a structure of a rotor.

FIG. 3 is a plan view illustrating an example of a stator.

FIG. 4 is a diagram schematically illustrating an internal structure of the stator illustrated in FIG. 3.

FIG. 5 is a schematic view illustrating an example of connection in three-phase coils.

FIG. 6 is a diagram illustrating first regions, second regions, and third regions in first phase coils.

FIG. 7 is a diagram illustrating an equivalent circuit of a connection pattern of three-phase coils in magnetizing a magnetic material by using the stator.

FIG. 8 is a flowchart depicting an example of a fabrication step of a stator.

FIG. 9 is a diagram illustrating an insertion step of external phase coils.

FIG. 10 is a diagram illustrating an insertion step of intermediate phase coils.

FIG. 11 is a diagram illustrating an insertion step of internal phase coils.

FIG. 12 is a flowchart depicting an example of a method for magnetizing magnetic materials of a rotor.

FIG. 13 is a diagram illustrating another example of the stator.

FIG. 14 is a diagram schematically illustrating an internal structure of the stator illustrated in FIG. 13.

FIG. 15 is a diagram illustrating an equivalent circuit of a connection pattern of three-phase coils in magnetizing a magnetic material by using a stator in a first variation.

FIG. 16 is a diagram illustrating another example of the stator.

FIG. 17 is a diagram schematically illustrating an internal structure of the stator illustrated in FIG. 16.

FIG. 18 is a diagram illustrating an equivalent circuit of a connection pattern of three-phase coils in magnetizing a magnetic material by using a stator in a second variation.

FIG. 19 is a diagram illustrating an equivalent circuit of a connection pattern of three-phase coils in magnetizing a magnetic material by using a stator in a third variation.

FIG. 20 is a diagram illustrating an equivalent circuit of a connection pattern of three-phase coils in magnetizing a magnetic material by using a stator in a fourth variation.

FIG. 21 is a diagram illustrating an equivalent circuit of a connection pattern of three-phase coils in magnetizing a magnetic material by using a stator in a fifth variation.

FIG. 22 is a plan view illustrating another example of the stator.

FIG. 23 is a diagram illustrating an equivalent circuit of a connection pattern of three-phase coils in magnetizing a magnetic material by using a stator in a sixth variation.

FIG. 24 is a diagram illustrating an equivalent circuit of a connection pattern of three-phase coils in magnetizing a magnetic material by using a stator in a seventh variation.

FIG. 25 is a diagram illustrating an example of electromagnetic forces in a radial direction generated in a coil end of three-phase coils when the three-phase coils are energized in a fabrication step of a stator 3, specifically, a magnetization step of a magnetic material.

FIG. 26 is a diagram illustrating an example of electromagnetic forces in an axial direction generated in a coil end of three-phase coils when the three-phase coils are energized in a fabrication step of a stator, specifically, a magnetization step of a magnetic material.

FIG. 27 is a graph showing a difference in magnitude of an electromagnetic force in a radial direction among connection patterns of three-phase coils when coils of each phase are energized in a magnetization step of a magnetic material.

FIG. 28 is a graph showing a difference in magnitude of an electromagnetic force in an axial direction among connection patterns of three-phase coils when coils of each phase are energized in a magnetization step of a magnetic material.

FIG. 29 is a graph showing a difference in magnitude of an electromagnetic force in a radial direction in each connection pattern of three-phase coils when two coils in the three-phase coils are energized in a magnetization step of a magnetic material.

FIG. 30 is a graph showing a difference in magnitude of an electromagnetic force in an axial direction in each connection pattern of three-phase coils when two coils in the three-phase coils are energized in a magnetization step of a magnetic material.

FIG. 31 is a cross-sectional view schematically illustrating a structure of a compressor according to a second embodiment of the present invention.

FIG. 32 is a diagram schematically illustrating a configuration of a refrigeration air conditioning apparatus according to a third embodiment of the present invention.

### DETAILED DESCRIPTION

### First Embodiment

In an xyz orthogonal coordinate system shown in each drawing, a z-axis direction (z axis) represents a direction parallel to an axis Ax of an electric motor 1, an x-axis direction (x axis) represents a direction orthogonal to the z-axis direction (z axis), and a y-axis direction (y axis) represents a direction orthogonal to both the z-axis direction and the x-axis direction. The axis Ax is a center of a stator 3, and is a rotation center of a rotor 2. A direction parallel to the axis Ax is also referred to as an “axial direction of the rotor 2” or simply as an “axial direction.” The radial direction refers to a radial direction of the rotor 2 or a stator 3, and is a direction orthogonal to the axis Ax. An xy plane is a plane orthogonal to the axial direction. An arrow D1 represents a circumferential direction about the axis Ax. The circumferential direction of the rotor 2 or the stator 3 will be also referred to simply as a “circumferential direction.”

### Structure of Electric Motor 1

FIG. 1 is a plan view schematically illustrating a structure of the electric motor 1 according to a first embodiment of the present invention.

The electric motor 1 includes the rotor 2 having a plurality of magnetic poles, the stator 3, and a shaft 4 fixed to the rotor 2. The electric motor 1 is, for example, a permanent magnet synchronous motor.

An air gap is present between the rotor 2 and the stator 3. The rotor 2 rotates about an axis Ax.

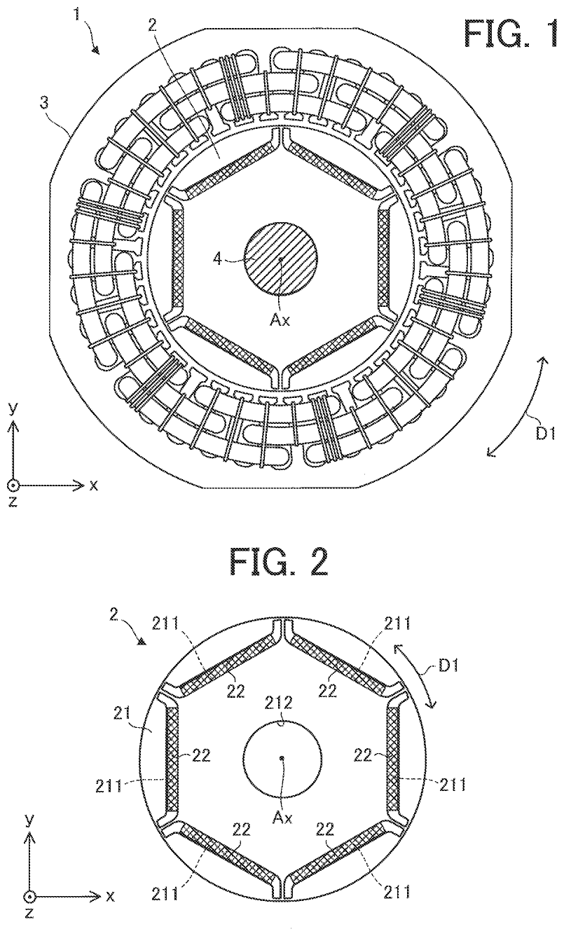

FIG. 2 is a plan view schematically illustrating the structure of the rotor 2.

The rotor 2 is rotatably disposed inside the stator 3. The rotor 2 includes a rotor core 21 and at least one magnetic material 22.

The rotor core 21 includes a plurality of magnet insertion holes 211 and a shaft hole 212. The rotor core 21 may further include at least one flux barrier portion that is a space communicating with each of the magnet insertion holes 211.

In this embodiment, the rotor 2 includes magnetic materials 22. Each of the magnetic materials 22 is disposed in a corresponding one of the magnet insertion holes 211. The shaft 4 is fixed to the shaft hole 212.

The magnetic materials 22 included in the electric motor 1 as a finished product are magnetized magnetic materials 22, that is, permanent magnets. In this embodiment, one magnetic material 22 forms one magnetic pole of the rotor 2, that is, a north pole or a south pole. It should be noted that two or more magnetic materials 22 may form one magnetic pole of the rotor 2.

In this embodiment, in the xy plane, one magnetic material 22 forming one magnetic pole of the rotor 2 is arranged in a straight line. Alternatively, in the xy plane, a pair of magnetic materials 22 forming one magnetic pole of the rotor 2 may be arranged to have a V shape.

A center of each magnetic pole of the rotor 2 is located at a center of each magnetic pole of the rotor 2 (i.e., a north pole or a south pole of the rotor 2). Each magnetic pole (hereinafter simply referred to as “each magnetic pole” or a “magnetic pole”) of the rotor 2 refers to a region serving as a north pole or a south pole of the rotor 2.

### Structure of Stator 3

The stator 3 is capable of magnetizing the magnetic materials 22 of the rotor 2 having 2×n (where n is a natural number) magnetic poles in a magnetization step described later.

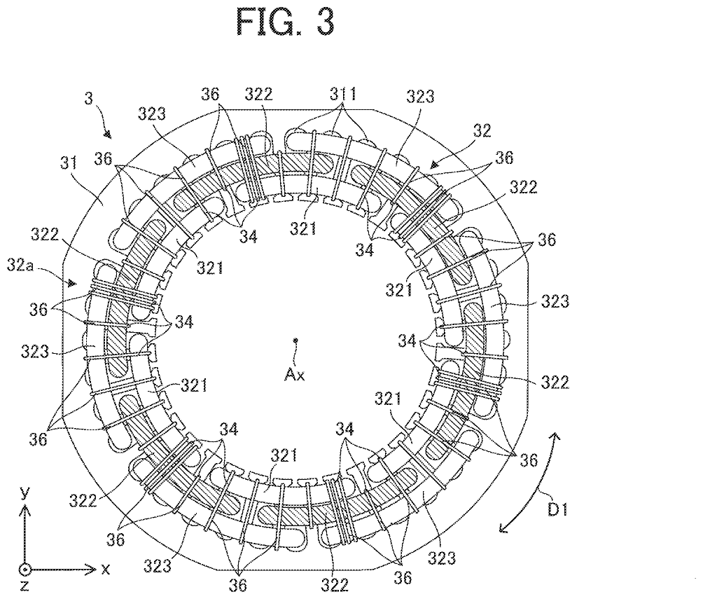

FIG. 3 is a plan view illustrating an example of the stator 3. A large current flows through the hatched coils from a source of electric power in the magnetization step described later. For example, in the example illustrated in FIG. 3, a current flowing through intermediate phase coils 322 is larger than each of a current flowing through internal phase coils 321 and a current flowing through external phase coils 323.

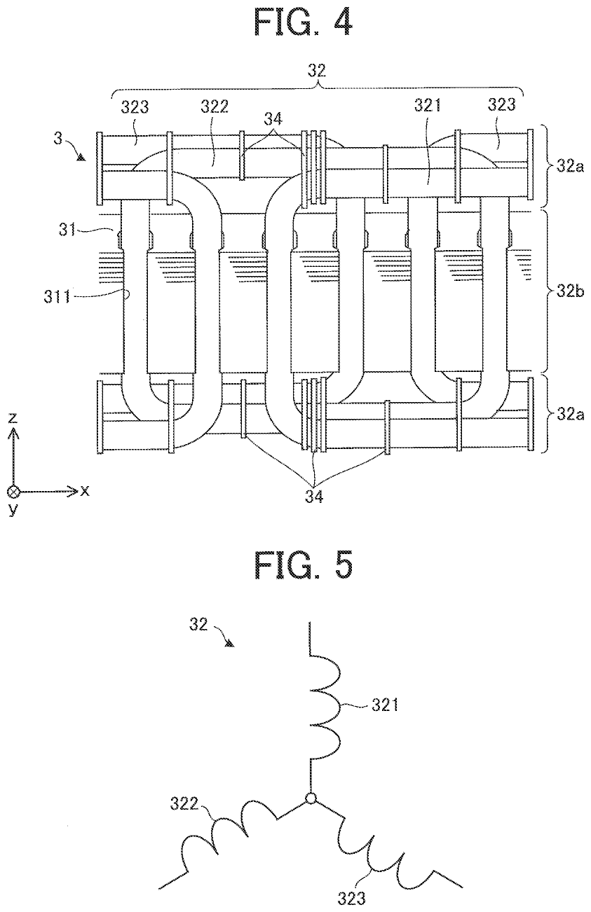

FIG. 4 is a diagram schematically illustrating an internal structure of the stator 3 illustrated in FIG. 3.

The stator 3 includes a stator core 31, three-phase coils 32, at least one lacing material 34 wound on the three-phase coils 32, and varnish 36.

The stator core 31 includes a plurality of slots 311 in which the three-phase coils 32 are disposed. In the example illustrated in FIG. 3, the stator core 31 includes 36 slots 311.

The three-phase coils 32 are attached to the stator core 31 by distributed winding. As illustrated in FIG. 4, the three-phase coils 32 include coil sides 32b disposed in the slots 311 and coil ends 32a not disposed in the slots 311. Each coil end 32a is an end portion of the three-phase coil 32 in the axial direction.

Each three-phase coil 32 includes at least one internal phase coil 321, at least one intermediate phase coil 322, and at least one external phase coil 323. That is, the three-phase coils 32 have a first phase, a second phase, and a third phase. For example, the first phase is a V phase, the second phase is a W phase, and the third phase is a U phase.

The three-phase coils 32 include 2×n first phase coils, 2×n second phase coils, and 2×n third phase coils. In this embodiment, n=3. Thus, in the example illustrated in FIG. 3, the three-phase coils 32 include six internal phase coils 321, six intermediate phase coils 322, and six external phase coils 323. The number of coils of each phase is not limited to six. In this embodiment, the stator 3 has the structure illustrated in FIG. 3 at two coil ends 32a. The stator 3 only needs to have the structure illustrated in FIG. 3 at one of the two coil ends 32a.

When a current flows through the three-phase coils 32, the three-phase coils 32 form 2×n magnetic poles. In this embodiment, n=3. Thus, in this embodiment, when a current flows through the three-phase coils 32, the three-phase coils 32 form six magnetic poles.

At the coil ends 32a of the three-phase coils 32, the second phase coils, the first phase coils, and the third phase coils of the three-phase coils 32 are repeatedly arranged in this order in the circumferential direction of the stator core 31. In the example illustrated in FIG. 3, at the coil ends 32a of the three-phase coils 32, the internal phase coils 321, the intermediate phase coils 322, and the external phase coils 323 of the three-phase coils 32 are repeatedly arranged in this order in the circumferential direction of the stator core 31.

At the coil ends 32a of the three-phase coils 32, the second phase coils, the first phase coils, and the third phase coils are arranged in this order from the inner side of the stator core 31 in the radial direction of the stator core 31. In the example illustrated in FIG. 3, the internal phase coils 321, the intermediate phase coils 322, and the external phase coils 323 are arranged in this order from the inner side of the stator core 31 in the radial direction of the stator core 31. Thus, at the coil ends 32a, in the radial direction of the stator core 31, the intermediate phase coils 322 are located outside the internal phase coils 321, and the external phase coils 323 are located outside the intermediate phase coils 322.

At the coil ends 32a, coils of each phase in the three-phase coils 32 have a ring shape. Specifically, in the example illustrated in FIG. 3, at the coil ends 32a, the six internal phase coils 321 have a ring shape, the six intermediate phase coils 322 have a ring shape, and the six external phase coils 323 have a ring shape.

At the coil ends 32a, coils of each phase in the three-phase coils 32 are concentrically arranged. Specifically, in the example illustrated in FIG. 3, at the coil ends 32a, the six internal phase coils 321 are concentrically arranged, the six intermediate phase coils 322 are concentrically arranged, and the six external phase coils 323 are concentrically arranged.

At the coil ends 32a, coils of each phase are arranged at regular intervals in the circumferential direction. A coil in any one of the phases is disposed in one slot 311. In this manner, magnetic flux of the magnetic materials 22 of the rotor 2 can be effectively used.

FIG. 5 is a schematic view illustrating an example of connection in the three-phase coils 32.

The connection in the three-phase coils 32 is, for example, Y connection. In other words, the three-phase coils 32 are connected by, for example, Y connection. In this case, the three-phase coils 32 have neutral points, and the internal phase coils 321, the intermediate phase coils 322, and the external phase coils 323 are connected by Y connection.

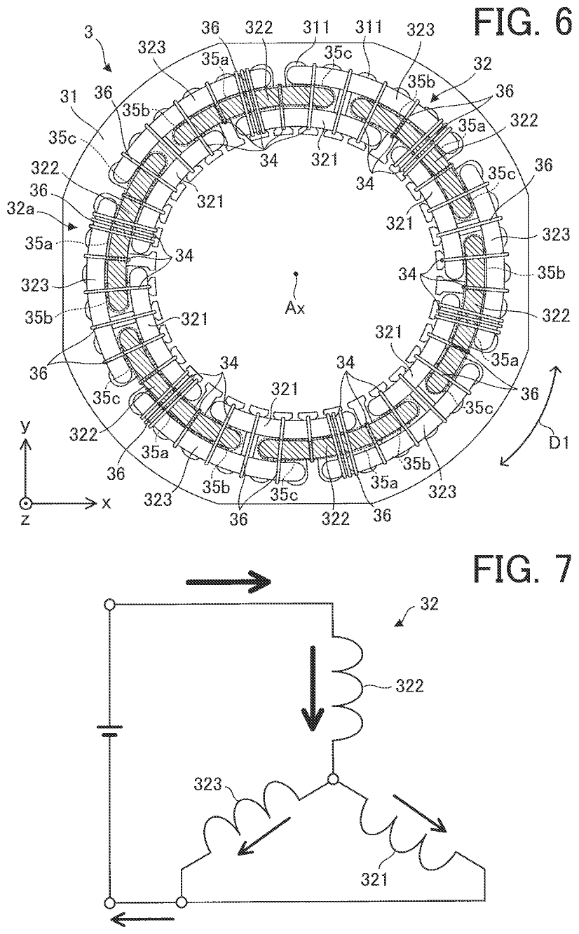

FIG. 6 is a diagram illustrating first regions 35a, second regions 35b, and third regions 35c in the first phase coils.

At the coil ends 32a of the three-phase coils 32, each of the 2×n first phase coils includes the first region 35a, the second region 35b, and the third region 35c that are equally divided. For example, as illustrated in FIG. 3, in a case where the first phase coils are the intermediate phase coils 322, at the coil ends 32a, each of the six intermediate phase coils 322 includes the first region 35a, the second region 35b, and the third region 35c.

The first region 35a is located between the second region 35b and the third region 35c. At the coil ends 32a of the three-phase coils 32, each first phase coil is equally divided into the first region 35a, the second region 35b, and the third region 35c. That is, in the xy plane, each first region 35a, each second region 35b, and each third region 35c has the same area.

The lacing material 34 is, for example, a cord. The varnish 36 adheres to the lacing material 34. Accordingly, the lacing material 34 is fixed to the three-phase coils 32.

At each of the coil ends 32a of the first phase coils, the lacing material 34 is wound on the first region 35a more than the second region 35b and the third region 35c. In other words, at each of the coil ends 32a of the first phase coils, the density of the lacing material 34 in the first region 35a is higher than at least one of the density of the lacing material 34 in the second region 35b or the density of the lacing material 34 in the third region 35c.

That is, the lacing material 34 may be wound on the first region 35a more than the second region 35b, the lacing material 34 may be wound on the first region 35a more than the third region 35c, and the lacing material 34 may be wound on the first region 35a more than each of the second region 35b and the third region 35c. In other words, at each of the coil ends 32a of the first phase coils, the density of the lacing material 34 in the first region 35a may be higher than the density of the lacing material 34 in the second region 35b, the density of the lacing material 34 in the first region 35a may be higher than the density of the lacing material 34 in the third region 35c, and the density of the lacing material 34 in the first region 35a may be higher than each of the density of lacing material 34 in the second region 35b and the density of the lacing material 34 in the third region 35c.

In this embodiment, at each of the coil ends 32a of the first phase coils (the intermediate phase coils 322 in this embodiment), the lacing material 34 is wound on the first region 35a more than each of the second region 35b and the third region 35c. In other words, at each of the coil ends 32a of the first phase coils (the intermediate phase coils 322 in this embodiment), the density of the lacing material 34 in the first region 35a is higher than each of the density of the lacing material 34 in the second region 35b and the density of the lacing material 34 in the third region 35c.

In a manner similar to the first phase coils, at the coil ends 32a of the three-phase coils 32, each of the 2×n second phase coils has a first region, a second region, and a third region that are equally divided. That is, in the xy plane, each first region, each second region, and each third region of the second phase coils have the same area. In this case, in each of the second phase coils, the first region is located between the second region and the third region.

In a manner similar to the first phase coil, at the coil ends 32a of the three-phase coils 32, each of the 2×n third phase coils have a first region, a second region, and a third region that are equally divided. That is, in the xy plane, each first region, each second region, and each third region of the third phase coils have the same area. In this case, in each of the third phase coils, the first region is located between the second region and the third region.

In the example illustrated in FIG. 3, at the coil ends 32a of the three-phase coils 32, the density of the lacing material 34 in the first region 35a of each first phase coil is higher than the density of the lacing material 34 in the first region of each second phase coil and the density of the lacing material 34 in the first region of each third phase coil. Accordingly, in the magnetization step of the magnetic materials 22 described later, significant deformation of the first phase coils through which a largest current flows among the three-phase coils 32 can be prevented.

FIG. 7 is a diagram illustrating an equivalent circuit of a connection pattern of the three-phase coils 32 in magnetizing the magnetic materials 22 by using the stator 3. In other words, FIG. 7 is a diagram illustrating an example of a connection state between the three-phase coils 32 connected by Y connection and the source of electric power for magnetization. Arrows in FIG. 7 represent directions of current. The source of electric power for magnetizing the magnetic materials 22 will be also referred to simply as a “source of electric power”. In this embodiment, the source of electric power is a direct-current source of electric power.

### Y Connection, Three-phase Electrification, Connection Pattern P1

In the example illustrated in FIG. 7, when a current flows through the three-phase coils 32 from the source of electric power for magnetization, the positive side of the source of electric power (i.e., the positive pole side of the source of electric power) is connected to the intermediate phase coil 322, and the negative side of the source of electric power (i.e., the negative pole side of the source of electric power) is connected to the internal phase coil 321 and the external phase coil 323. The connection state illustrated in FIG. 7 will be referred to as a connection pattern P1. When a current flows through the three-phase coils 32 from the source of electric power for magnetization, an electrification method for causing a current to flow through coils of each phase will be referred to as “three-phase electrification.”

Although the circuit diagram illustrated in FIG. 7 is an equivalent circuit diagram, in an actual magnetization step, when a current flows through the three-phase coils 32 from the source of electric power for magnetization, each of the 2×n first phase coils is connected to the positive side or the negative side of the source of electric power. In the connection pattern P1, the first phase coils are coils through which the largest current flows among the three-phase coils 32 when a current flows through the three-phase coils 32 from the source of electric power for magnetization.

In the connection pattern P1, when a current flows through the three-phase coils 32 from the source of electric power for magnetization in the magnetization step, a current flowing through each first phase coil is larger than a current flowing through each second phase coil, and is larger than a current flowing through each third phase coil. That is, in the magnetization step, when a current flows through the three-phase coils 32 from the source of electric power for magnetization, a current flowing through each first phase coil may be larger than a current flowing through each second phase coil, a current flowing through each first phase coil may be larger than a current flowing through each third phase coil, and a current flowing through each first phase coil may be larger than both of a current flowing through each second phase coil and a current flowing through each third phase coil.

In the connection pattern P1, a current flowing through the first phase coils from the source of electric power for magnetization is branched into a current flowing through the second phase coils and a current flowing through the third phase coils. That is, in the connection pattern P1, a large current flows through the intermediate phase coils 322 from the source of electric power. The current flowing through the intermediate phase coils 322 from the source of electric power is branched into as a current flowing through the internal phase coils 321 and a current flowing through the external phase coils 323. Thus, the current flowing through the intermediate phase coils 322 is larger than each of a current flowing through the internal phase coils 321 and a current flowing through the external phase coils 323.

### Method for Fabricating Stator 3

An example of a method for fabricating the stator 3 will be described.

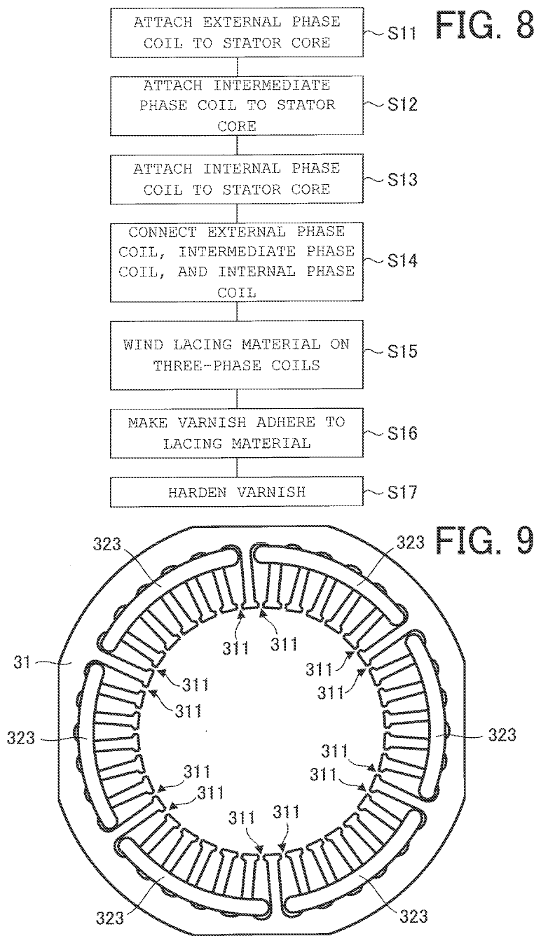

FIG. 8 is a flowchart depicting an example of a process for fabricating the stator 3.

FIG. 9 is a diagram illustrating an insertion step of the external phase coils 323 in step S11.

In step S11, as illustrated in FIG. 9, the external phase coils 323 are attached to a previously prepared stator core 31 by distributed winding. Specifically, the external phase coils 323 are inserted in the slots 311 of the stator core 31 by an insertion tool.

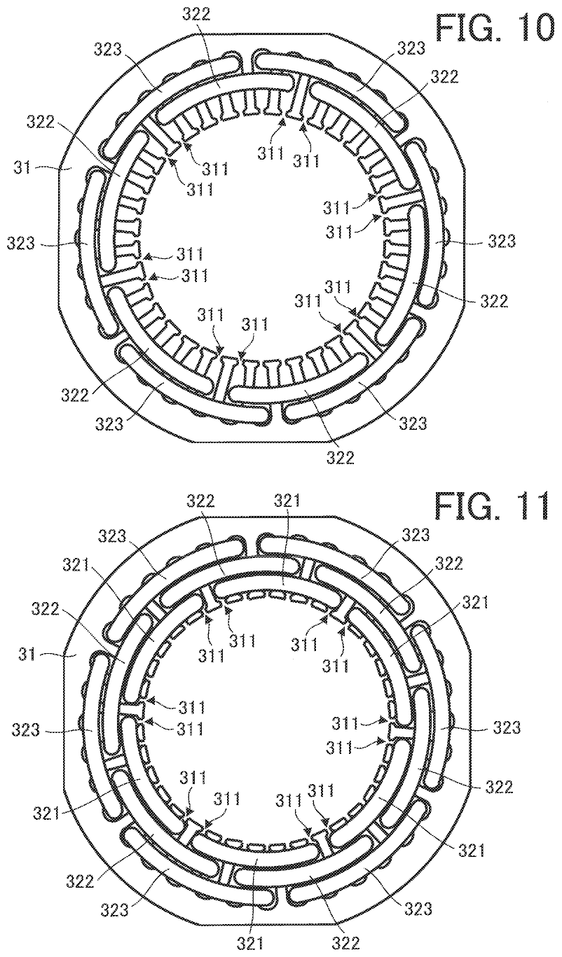

FIG. 10 is a diagram illustrating an insertion step of the intermediate phase coils 322 in step S12.

In step S12, as illustrated in FIG. 10, the intermediate phase coils 322 are attached to the stator core 31 by distributed winding. Specifically, the intermediate phase coils 322 are inserted in the slots 311 of the stator core 31 by an insertion tool.

FIG. 11 is a diagram illustrating an insertion step of the internal phase coils 321 in step S13.

In step S13, as illustrated in FIG. 11, the internal phase coils 321 are attached to the stator core 31 by distributed winding. Specifically, the internal phase coils 321 are inserted in the slots 311 of the stator core 31 by an insertion tool.

In step S11 through step S13, at each of the coil ends 32a of the three-phase coils 32, the three-phase coils 32 are attached to the stator core 31 by distributed winding so that the intermediate phase coils 322, the internal phase coils 321, the external phase coils 323 are repeatedly arranged in this order in the circumferential direction of the stator core 31.

In other words, in step S11 through step S13, at each of the coil ends 32a of the three-phase coils 32, the three-phase coils 32 are attached to the stator core 31 by distributed winding so that the internal phase coils 321, the intermediate phase coils 322, and the external phase coils 323 are arranged in this order from the inner side of the stator core 31 in the radial direction of the stator core 31.

Accordingly, in step S11 through step S13, at each of the coil ends 32a of the three-phase coils 32, the three-phase coils 32 are attached to the stator core 31 so that the intermediate phase coils 322 are located outside the internal phase coils 321 and the external phase coils 323 are located outside the intermediate phase coil 322 in the radial direction of the stator core 31.

In step S14, the internal phase coils 321, the intermediate phase coils 322, and the external phase coils 323 are connected. For example, the internal phase coils 321, the intermediate phase coils 322, and the external phase coils 323 are connected by Y connection or delta connection. In this embodiment, the internal phase coils 321, the intermediate phase coils 322, and the external phase coils 323 are connected by Y connection. Thereafter, the shape of the connected three-phase coils 32 is appropriately adjusted.

In step S15, a lacing material 34 is attached to the three-phase coils 32. In this embodiment, as illustrated in FIGS. 3 and 4, the lacing material 34 is wound on the three-phase coils 32.

For example, the lacing material 34 is wound on the internal phase coils 321 and the intermediate phase coils 322. Accordingly, the internal phase coils 321 and the intermediate phase coils 322 are fixed by the lacing material 34.

Similarly, the lacing material 34 is wound on the intermediate phase coils 322 and the external phase coils 323. Accordingly, the intermediate phase coils 322 and the external phase coils 323 are fixed by the lacing material 34.

In addition, the lacing material 34 may be wound on the internal phase coils 321, the intermediate phase coils 322, and the external phase coils 323. Accordingly, the internal phase coils 321, the intermediate phase coils 322, and the external phase coils 323 are fixed by the lacing material 34.

In step S15, at each of the coil ends 32a of each first phase coil, the lacing material 34 is wound on the first region 35a more than at least one of the second region 35b or the third region 35c. In other words, at each of the coil ends 32a of each first phase coil, the lacing material 34 is wound on the three-phase coils 32 so that the density of the lacing material 34 in the first region 35a is higher than at least one of the density of the lacing material 34 in the second region 35b or the density of the lacing material 34 in the third region 35c.

In this embodiment, at each of the coil ends 32a of each first phase coil (each intermediate phase coil 322 in this embodiment), the lacing material 34 is wound on the first region 35a more than each of the second region 35b and the third region 35c. In other words, at each of the coil ends 32a of each first phase coil (each intermediate phase coil 322 in this embodiment), the lacing material 34 is wound on the three-phase coils 32 so that the density of the lacing material 34 in the first region 35a is higher than each of the density of the lacing material 34 in the second region 35b and the density of the lacing material 34 in the third region 35c.

In step S16, the varnish 36 is made to adhere to the lacing material 34. For example, the lacing material 34 is immersed in the varnish 36.

At each of the coil ends 32a of each first phase coil (each intermediate phase coil 322 in this embodiment), since the lacing material 34 is wound on the first region 35a more than each of the second region 35b and the third region 35c, the amount of varnish 36 adhering to the lacing material 34 in the first region 35a is larger than the amount of varnish adhering to the lacing material 34 in the second region 35b and the amount of varnish adhering to the lacing material 34 in the third region 35c. Accordingly, holding power of the lacing material 34 in the first region 35a is enhanced. Consequently, the first phase coils (the intermediate phase coils 322 in this embodiment) can be firmly fixed, and the amount of the varnish 36 in the stator 3 can be reduced as compared to a conventional technique.

In step S17, the varnish 36 adhering to the lacing material 34 is hardened. For example, the varnish 36 adhering to the lacing material 34 is heated by a heater and consequently the varnish 36 is hardened. Accordingly, the three-phase coils 32 are fixed by the lacing material 34, and thus the stator 3 illustrated in FIG. 3 is obtained.

### Method for Magnetizing Magnetic Material 22 of Rotor 2 Using Stator 3

A method for magnetizing the magnetic materials 22 of the rotor 2 using the stator 3 will be described.

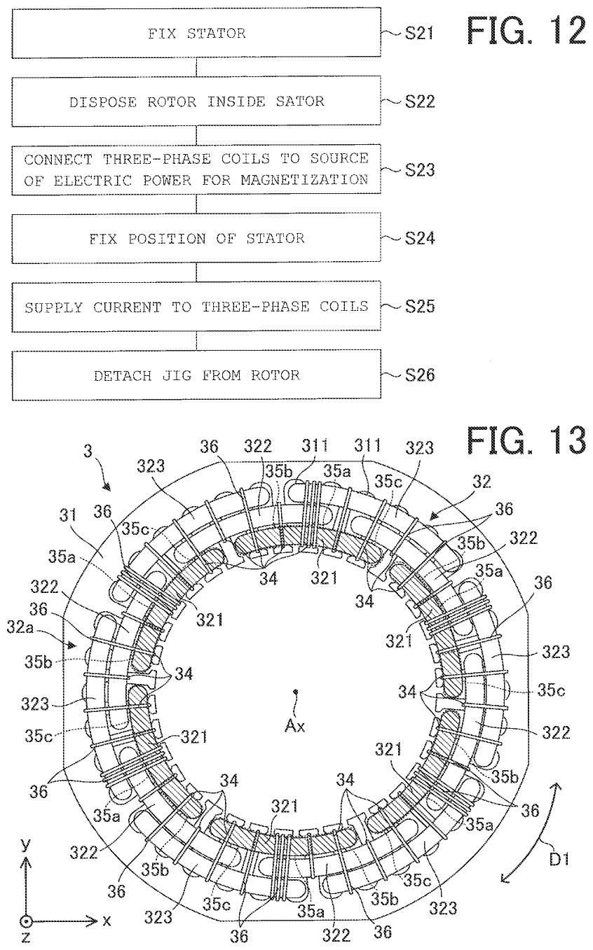

FIG. 12 is a flowchart depicting an example of a method for magnetizing the magnetic materials 22 of the rotor 2.

In step S21, the stator 3 is fixed. For example, the stator 3 is fixed in a compressor or an electric motor by a fixing method such as press fitting or shrink fitting.

In step S22, the rotor is disposed inside the stator 3. At least one of magnetic material 22 is attached to this rotor.

In step S23, three-phase coils 32 are connected to a source of electric power for magnetization. For example, first phase coils are connected to a positive side or a negative side of the source of electric power. The connection between the three-phase coils 32 and the source of electric power is, for example, the connection pattern P1 described above. The connection between the three-phase coils 32 and the source of electric power may be any one of connection patterns P2 through P8 according to variations described later.

In step S24, a position of the rotor 2 (specifically, a phase of the rotor 2) having at least one magnetic material 22 is fixed by a jig.

Step S25 is a step of magnetizing the magnetic material 22 (which will be referred to simply as a “magnetization step”). In step S25, the magnetic material 22 is magnetized. Specifically, a current is supplied from the source of electric power to the three-phase coils 32 so that a largest current flows through the first phase coils.

In the connection pattern P1, a large current flows through the intermediate phase coils 322 from the source of electric power. The current flowing through the intermediate phase coils 322 from the source of electric power is branched into as a current flowing through the internal phase coils 321 and a current flowing through the external phase coils 323. Thus, the current flowing through the intermediate phase coils 322 is larger than each of a current flowing through the internal phase coils 321 and a current flowing through the external phase coils 323.

A current flowing through the three-phase coils 32 from the source of electric power generates a magnetic field, and the magnetic material 22 of the rotor 2 is magnetized. Accordingly, the magnetic material 22 changes to a permanent magnet.

In step S26, the jig used in step S24 is detached from the rotor.

Other examples of the stator 3, that is, first through seventh variations, will be described with respect to aspects different from those described in the first embodiment.

### First Variation <Y Connection, Three-Phase Electrification, Connection Pattern P2>

FIG. 13 is another example of the stator 3.

FIG. 14 is a diagram schematically illustrating an internal structure of the stator 3 illustrated in FIG. 13.

In the stator 3 illustrated in FIGS. 13 and 14 (hereinafter also referred to as a first variation), the first phase coils are the internal phase coils 321, the second phase coils are the intermediate phase coils 322, and the third phase coils are the external phase coils 323.

That is, in the first variation, at the coil ends 32a of the three-phase coils 32, the first phase coils, the second phase coils, and the third phase coils of the three-phase coils 32 are repeatedly arranged in this order in the circumferential direction of the stator core 31, and the first phase coils, the second phase coils, and the third phase coils are arranged in this order from the inner side of the stator core 31 in the radial direction of the stator core 31.

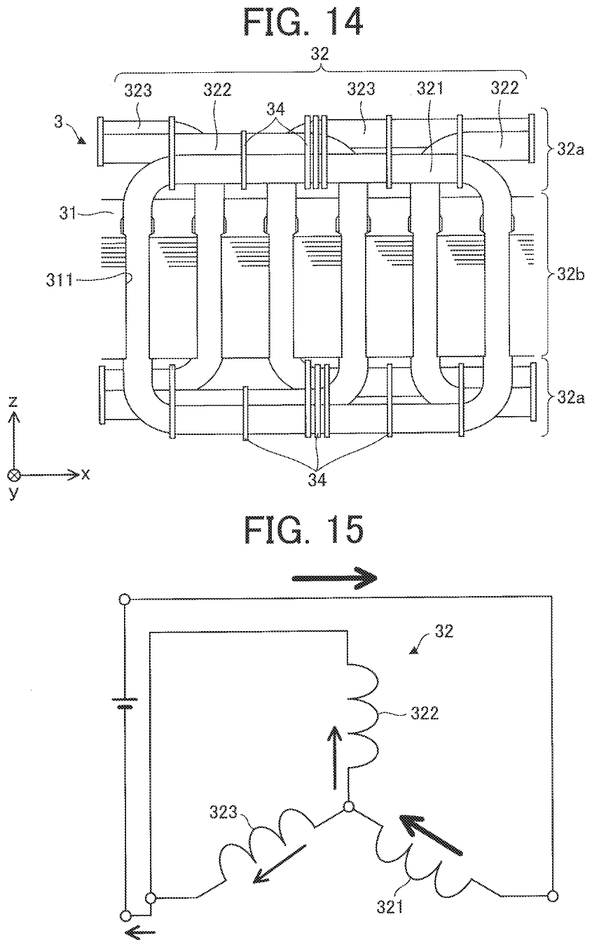

FIG. 15 is a diagram illustrating an equivalent circuit of a connection pattern of the three-phase coils 32 in magnetizing the magnetic material 22 by using the stator 3 in the first variation. In other words, FIG. 15 is a diagram illustrating an example of a connection state between the three-phase coils 32 connected by Y connection and the source of electric power for magnetization in the first variation. Arrows in FIG. 15 represent directions of current.

In the example illustrated in FIG. 15, when a current flows through the three-phase coils 32 from the source of electric power for magnetization, the positive side of the source of electric power (i.e., the positive pole side of the source of electric power) is connected to the internal phase coils 321, and the negative side of the source of electric power (i.e., the negative pole side of the source of electric power) is connected to the intermediate phase coils 322 and the external phase coils 323. The connection state illustrated in FIG. 15 will be referred to as a connection pattern P2.

Although the circuit diagram illustrated in FIG. 15 is an equivalent circuit diagram, in an actual magnetization step, when a current flows through the three-phase coils 32 from the source of electric power for magnetization, each of the 2×n first phase coils is connected to the positive side or the negative side of the source of electric power.

In the connection pattern P2, a large current flows through the internal phase coils 321 from the source of electric power. The current flowing through the internal phase coils 321 from the source of electric power is branched into as a current flowing through the intermediate phase coils 322 and a current flowing through the external phase coils 323. Thus, a current flowing through the internal phase coils 321 is larger than each of a current flowing through the intermediate phase coils 322 and a current flowing through the external phase coils 323.

In the first variation, the first phase coils are coils through which the largest current flows among the three-phase coils 32 when a current flows through the three-phase coils 32 from the source of electric power for magnetization.

In the first variation, at the coil ends 32a of the three-phase coils 32, the density of the lacing material 34 in the first region 35a of each first phase coil is higher than the density of the lacing material 34 in the first region of each second phase coil and the density of the lacing material 34 in the first region of each third phase coil. Accordingly, in the magnetization step of the magnetic material 22, significant deformation of the first phase coils through which a largest current flows among the three-phase coils 32 can be prevented.

### Second Variation <Y Connection, Two-Phase Electrification, Connection Pattern P3>

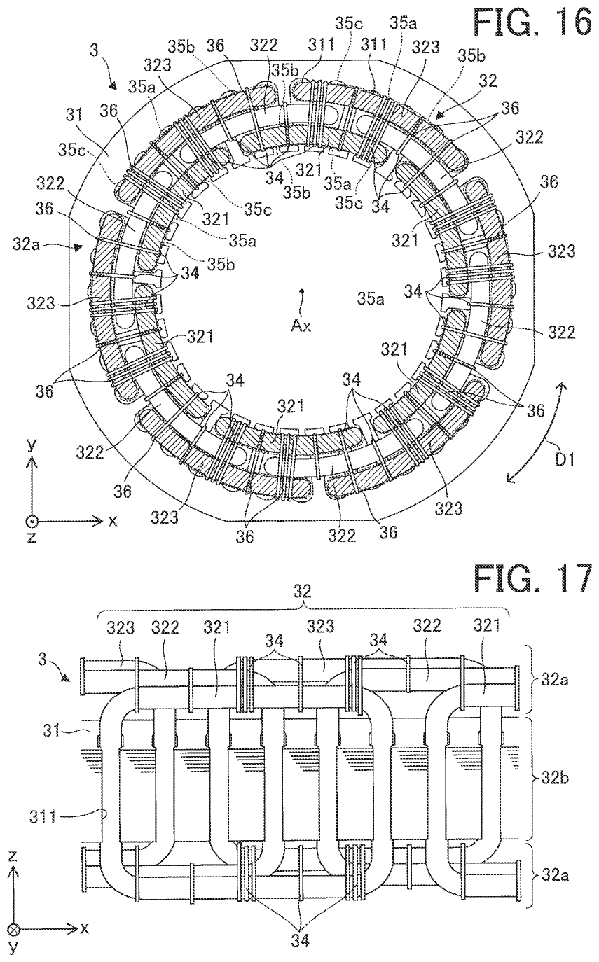

FIG. 16 is another example of the stator 3.

FIG. 17 is a diagram schematically illustrating an internal structure of the stator 3 illustrated in FIG. 16.

In the stator 3 illustrated in FIGS. 16 and 17 (hereinafter also referred to as a second variation), the first phase coils are the internal phase coils 321, the second phase coils are the external phase coils 323, and the third phase coils are the intermediate phase coils 322.

In this case, at the coil ends 32a of the three-phase coils 32, the first phase coils, the third phase coils, and the second phase coils of the three-phase coils 32 are repeatedly arranged in this order in the circumferential direction of the stator core 31, and the first phase coil, the third phase coil, and the second phase coil are arranged in this order from the inner side of the stator core 31 in the radial direction of the stator core 31.

In the second variation, the first phase coils may be the external phase coils 323. In this case, the internal phase coils 321 are, for example, the second phase coils.

In the second variation, each internal phase coil 321 has a first region 35a, a second region 35b, and a third region 35c, and each external phase coil 323 also has a first region 35a, a second region 35b, and a third region 35c.

In each of the coil ends 32a, the lacing material 34 is wound on the first region 35a more than at least one of the second region 35b or the third region 35c. In other words, at each of the coil ends 32a, the density of the lacing material 34 in the first region 35a is higher than at least one of the density of the lacing material 34 in the second region 35b or the density of the lacing material 34 in the third region 35c.

In the example illustrated in FIG. 16, at each of the coil ends 32a, the lacing material 34 is wound on the first region 35a more than the second region 35b. In other words, at each of the coil ends 32a, the density of the lacing material 34 in the first region 35a is higher than the density of the lacing material 34 in the second region 35b.

FIG. 18 is a diagram illustrating an equivalent circuit of a connection pattern of the three-phase coils 32 in magnetizing the magnetic material 22 by using the stator 3 in the second variation. In other words, FIG. 18 is a diagram illustrating an example of a connection state between the three-phase coils 32 connected by Y connection and the source of electric power for magnetization in the second variation. Arrows in FIG. 18 represent directions of current.

In the example illustrated in FIG. 18, when a current flows through the three-phase coils 32 from the source of electric power for magnetization, the positive side of the source of electric power is connected to the internal phase coils 321, and the negative side of the source of electric power is connected to the external phase coils 323. One end of each intermediate phase coil 322 is connected to a neutral point, and the other end is a free end. The connection state illustrated in FIG. 18 will be referred to as a connection pattern P3. When a current flows through the three-phase coils 32 from the source of electric power for magnetization, an electrification method for causing a current to flow in two of the three phases will be referred to as “two-phase electrification.”

In the connection pattern P3, a current flowing through the first phase coils from the source of electric power for magnetization flows through the second phase coils and does not flow through the third phase coils. In this embodiment, a large current flows through the internal phase coils 321 and the external phase coils 323 from the source of electric power. The current flowing through the internal phase coils 321 from the source of electric power flows through the external phase coils 323 and does not flow in the intermediate phase coils 322.

In the second variation, the first phase coils and the second phase coils are coils through which the largest current flows among the three-phase coils 32 when a current flows through the three-phase coils 32 from the source of electric power for magnetization.

In the second variation, the density of the lacing material 34 in the first region 35a of each first phase coil is higher than the density of the lacing material 34 in the first region of each third phase coil, and the density of the lacing material 34 in the first region 35a of each second phase coil is higher than the density of the lacing material 34 in the first region of each third phase coil. Accordingly, in the magnetization step of the magnetic material 22, a largest current among the three-phase coils 32 flows through the first phase coils and the second phase coils, and thus, significant deformation of the first phase coils and the second phase coils can be prevented in the magnetization step of the magnetic material 22.

### Third Variation <Delta Connection, Three-Phase Electrification, Connection Pattern P4>

In a third variation, the structure of the stator 3 is the same as the structure of the stator 3 illustrated in FIGS. 3 and 4, and a connection pattern of the three-phase coils 32 in magnetizing the magnetic material 22 using the stator 3 is different from the connection pattern P1 illustrated in FIG. 7.

In the third variation, the connection in the three-phase coils 32 is delta connection. In other words, the three-phase coils 32 are connected by delta connection. In this case, the internal phase coils 321, the intermediate phase coils 322, and the external phase coils 323 are connected by delta connection.

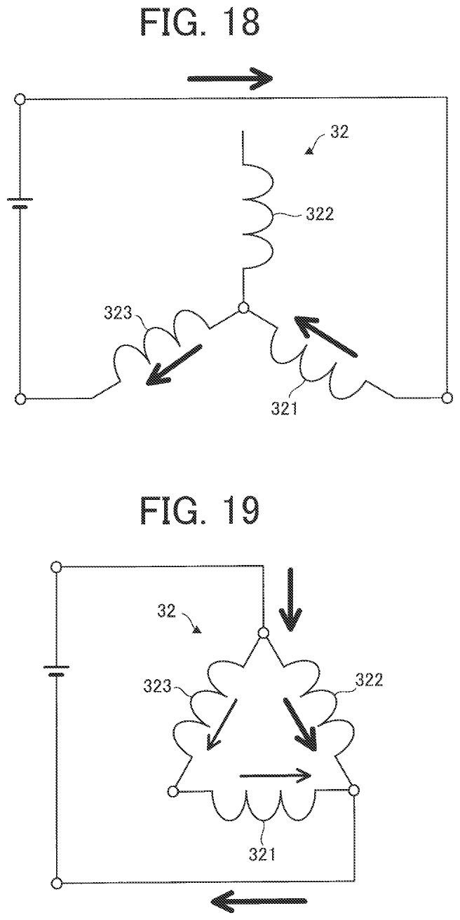

FIG. 19 is a diagram illustrating an equivalent circuit of a connection pattern of the three-phase coils 32 in magnetizing the magnetic material 22 by using the stator 3 in the third variation. In other words, FIG. 19 is a diagram illustrating an example of a connection state between the three-phase coils 32 connected by delta connection and the source of electric power for magnetization in the third variation. Arrows in FIG. 19 represent directions of current.

In the example illustrated in FIG. 19, when a current flows through the three-phase coils 32 from the source of electric power for magnetization, the positive side of the source of electric power is connected to the intermediate phase coils 322 and the external phase coils 323, and the negative side of the source of electric power is connected to the internal phase coils 321 and the intermediate phase coils 322. The connection state illustrated in FIG. 19 will be referred to as a connection pattern P4.

In the connection pattern P4, a current flows through the internal phase coils 321, the intermediate phase coils 322, and the external phase coils 323 from the source of electric power. Since the external phase coils 323 and the internal phase coils 321 are connected in series, an electrical resistance from the external phase coils 323 to the internal phase coils 321 is larger than an electrical resistance of the intermediate phase coils 322. Thus, a current flowing through the external phase coils 323 and the internal phase coils 321 is smaller than a current flowing through the intermediate phase coils 322, and a current flowing through the intermediate phase coils 322 is larger than each of a current flowing through the external phase coils 323 and a current flowing through the internal phase coils 321.

In the third variation, the first phase coils are coils through which the largest current flows among the three-phase coils 32 when a current flows through the three-phase coils 32 from the source of electric power for magnetization.

In the third variation, at the coil ends 32a of the three-phase coils 32, the density of the lacing material 34 in the first region 35a of each first phase coil is higher than the density of the lacing material 34 in the first region of each second phase coil and the density of the lacing material 34 in the first region of each third phase coil. Accordingly, in the magnetization step of the magnetic material 22, significant deformation of the first phase coils through which a largest current flows among the three-phase coils 32 can be prevented.

### Fourth Variation <Delta Connection, Three-Phase Electrification, Connection Pattern P5>

In a fourth variation, the structure of the stator 3 is the same as the structure of the first variation illustrated in FIGS. 13 and 14, and a connection pattern of the three-phase coils 32 in magnetizing the magnetic material 22 using the stator 3 is different from the connection pattern P2 in the first variation.

In the fourth variation, the connection in the three-phase coils 32 is delta connection. In other words, the three-phase coils 32 are connected by delta connection. In this case, the internal phase coils 321, the intermediate phase coils 322, and the external phase coils 323 are connected by delta connection.

FIG. 20 is a diagram illustrating an equivalent circuit of a connection pattern of the three-phase coils 32 in magnetizing the magnetic material 22 by using the stator 3 in the fourth variation. In other words, FIG. 20 is a diagram illustrating an example of a connection state between the three-phase coils 32 connected by delta connection and the source of electric power for magnetization in the fourth variation. Arrows in FIG. 20 represent directions of current.

In the example illustrated in FIG. 20, when a current flows through the three-phase coils 32 from the source of electric power for magnetization, the positive side of the source of electric power is connected to the intermediate phase coils 322 and the internal phase coils 321, and the negative side of the source of electric power is connected to the internal phase coils 321 and the external phase coils 323. The connection state illustrated in FIG. 20 will be referred to as a connection pattern P5.

In the connection pattern P5, a current flows through the internal phase coils 321, the intermediate phase coils 322, and the external phase coils 323 from the source of electric power. Since the intermediate phase coils 322 and the external phase coils 323 are connected in series, an electrical resistance from the intermediate phase coils 322 to the external phase coils 323 is larger than an electrical resistance of the internal phase coils 321. Thus, a current flowing through the intermediate phase coils 322 and the external phase coils 323 is smaller than a current flowing through the internal phase coils 321, and a current flowing through the internal phase coils 321 is larger than each of a current flowing through the intermediate phase coils 322 and a current flowing through the external phase coils 323.

In the fourth variation, the first phase coils are coils through which the largest current flows among the three-phase coils 32 when a current flows through the three-phase coils 32 from the source of electric power for magnetization.

In the fourth variation, at the coil ends 32a of the three-phase coils 32, the density of the lacing material 34 in the first region 35a of each first phase coil is higher than the density of the lacing material 34 in the first region of each second phase coil and the density of the lacing material 34 in the first region of each third phase coil. Accordingly, in the magnetization step of the magnetic materials 22, significant deformation of the first phase coils through which a largest current flows among the three-phase coils 32 can be prevented.

### Fifth Variation <Delta Connection, Two-Phase Electrification, Connection Pattern P6>

In a fifth variation, the structure of the stator 3 is the same as the structure of the second variation illustrated in FIGS. 16 and 17, and a connection pattern of the three-phase coils 32 in magnetizing the magnetic material 22 using the stator 3 is different from the connection pattern P3 in the second variation.

In the fifth variation, the connection in the three-phase coils 32 is delta connection. In other words, the three-phase coils 32 are connected by delta connection. In this case, the internal phase coils 321, the intermediate phase coils 322, and the external phase coils 323 are connected by delta connection.

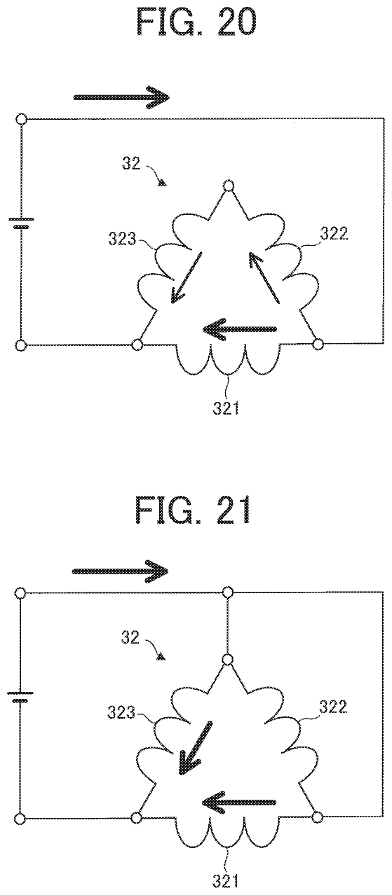

FIG. 21 is a diagram illustrating an equivalent circuit of a connection pattern of the three-phase coils 32 in magnetizing the magnetic material 22 by using the stator 3 in the fifth variation. In other words, FIG. 21 is a diagram illustrating an example of a connection state between the three-phase coils 32 connected by delta connection and the source of electric power for magnetization in the fifth variation. Arrows in FIG. 21 represent directions of current.

In the example illustrated in FIG. 21, when a current flows through the three-phase coils 32 from the source of electric power for magnetization, the positive side of the source of electric power is connected to the external phase coils 323, the intermediate phase coils 322, and the internal phase coils 321, and the negative side of the source of electric power is connected to the internal phase coils 321 and the external phase coils 323. The connection state illustrated in FIG. 21 will be referred to as a connection pattern P6.

In the connection pattern P6, a current flows through the internal phase coils 321 and the external phase coils 323 from the source of electric power, and no current flows through the intermediate phase coils 322. Accordingly, a large current flows through the internal phase coils 321 and the external phase coils 323.

In the fifth variation, the first phase coils and the second phase coils are coils through which the largest current flows among the three-phase coils 32 when a current flows through the three-phase coils 32 from the source of electric power for magnetization.

In the fifth variation, the density of the lacing material 34 in the first region 35a of each first phase coil is higher than the density of the lacing material 34 in the first region of each third phase coil, and the density of the lacing material 34 in the first region 35a of each second phase coil is higher than the density of the lacing material 34 in the first region of each third phase coil. Accordingly, in the magnetization step of the magnetic material 22, a largest current among the three-phase coils 32 flows through the first phase coils and the second phase coils, and thus, significant deformation of the first phase coils and the second phase coils can be prevented in the magnetization step of the magnetic material 22.

### Sixth Variation <Y Connection, Three-Phase Electrification, Connection Pattern P7>

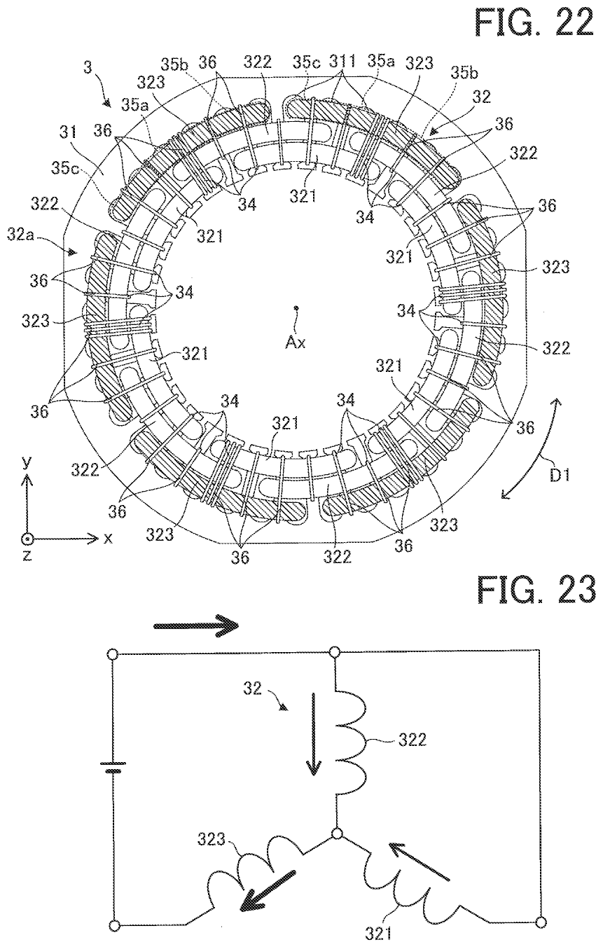

FIG. 22 is a plan view illustrating another example of the stator 3.

In a sixth variation, the first phase coils are the external phase coils 323, the second phase coils are the intermediate phase coils 322, and the third phase coils are the internal phase coils 321.

That is, in the sixth variation, at the coil ends 32a of the three-phase coils 32, the third phase coils, the second phase coils, and the first phase coils of the three-phase coils 32 are repeatedly arranged in this order in the circumferential direction of the stator core 31, and the third phase coils, the second phase coils, and the first phase coils are arranged in this order from the inner side of the stator core 31 in the radial direction of the stator core 31.

FIG. 23 is a diagram illustrating an equivalent circuit of a connection pattern of the three-phase coils 32 in magnetizing the magnetic material 22 by using the stator 3 in the sixth variation. In other words, FIG. 23 is a diagram illustrating an example of a connection state between the three-phase coils 32 connected by Y connection and the source of electric power for magnetization in the sixth variation. Arrows in FIG. 23 represent directions of current.

In the example illustrated in FIG. 23, when a current flows through the three-phase coils 32 from the source of electric power for magnetization, the positive side of the source of electric power is connected to the internal phase coils 321 and the intermediate phase coils 322, and the negative side of the source of electric power is connected to the external phase coils 323. The connection state illustrated in FIG. 23 will be referred to as a connection pattern P7.

In the connection pattern P7, a current from the source of electric power is branched into a current flowing through the internal phase coils 321 and a current flowing through the intermediate phase coils 322, and these currents flow in the external phase coils 323. Thus, a current flowing through the external phase coils 323 is larger than each of a current flowing through the internal phase coils 321 and a current flowing through the intermediate phase coils 322.

In the sixth variation, the first phase coils are coils through which the largest current flows among the three-phase coils 32 when a current flows through the three-phase coils 32 from the source of electric power for magnetization.

In the sixth variation, at the coil ends 32a of the three-phase coils 32, the density of the lacing material 34 in the first region 35a of each first phase coil is higher than the density of the lacing material 34 in the first region of each second phase coil and the density of the lacing material 34 in the first region of each third phase coil. Accordingly, in the magnetization step of the magnetic material 22, significant deformation of the first phase coils through which a largest current flows among the three-phase coils 32 can be prevented.

### Seventh Variation <Delta Connection, Three-Phase Electrification, Connection Pattern P8>

In a seventh variation, the structure of the stator 3 is the same as the structure of the stator 3 illustrated in FIG. 22, and a connection pattern of the three-phase coils 32 in magnetizing the magnetic material 22 using the stator 3 is different from the connection pattern P7 illustrated in FIG. 23.

In the seventh variation, the connection in the three-phase coils 32 is delta connection. In other words, the three-phase coils 32 are connected by delta connection. In this case, the internal phase coils 321, the intermediate phase coils 322, and the external phase coils 323 are connected by delta connection.

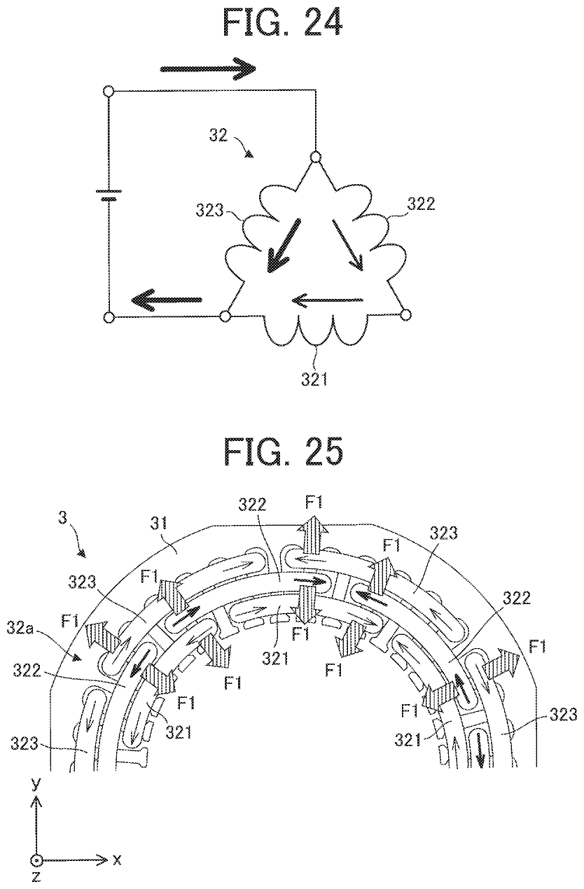

FIG. 24 is a diagram illustrating an equivalent circuit of a connection pattern of the three-phase coils 32 in magnetizing the magnetic material 22 by using the stator 3 in the seventh variation. In other words, FIG. 24 is a diagram illustrating an example of a connection state between the three-phase coils 32 connected by delta connection and the source of electric power for magnetization in the seventh variation. Arrows in FIG. 24 represent directions of current.

In the example illustrated in FIG. 24, when a current flows through the three-phase coils 32 from the source of electric power for magnetization, the positive side of the source of electric power is connected to the intermediate phase coils 322 and the external phase coils 323, and the negative side of the source of electric power is connected to the internal phase coils 321 and the external phase coils 323. The connection state illustrated in FIG. 24 will be referred to as a connection pattern P8.

In the connection pattern P8, a current flowing through the external phase coils 323 is larger than each of a current flowing through the internal phase coils 321 and a current flowing through the intermediate phase coils 322.

In the seventh variation, the first phase coils are coils through which the largest current flows among the three-phase coils 32 when a current flows through the three-phase coils 32 from the source of electric power for magnetization.

In the seventh variation, at the coil ends 32a of the three-phase coils 32, the density of the lacing material 34 in the first region of each first phase coil is higher than the density of the lacing material 34 in the first region of each second phase coil and the density of the lacing material 34 in the first region of each third phase coil. Accordingly, in the magnetization step of the magnetic materials 22, significant deformation of the first phase coils through which a largest current flows among the three-phase coils 32 can be prevented.

### Advantages of Stator 3

Advantages of the stator 3 will be described. FIG. 25 is a diagram illustrating an example of electromagnetic forces F1 in a radial direction generated in the coil ends 32a of the three-phase coils 32 when the three-phase coils 32 are energized in a fabrication step of the stator 3, specifically, a magnetization step of the magnetic materials 22. In FIG. 25, arrows in the three-phase coils 32 represent directions of current.

In the example illustrated in FIG. 25, when a current flows through the three-phase coils 32 from the source of electric power for magnetization, electromagnetic forces F1 that are repulsive to each other in the radial direction are generated between the intermediate phase coils 322 and the external phase coils 323. The electromagnetic forces F1 are also called Lorentz forces.

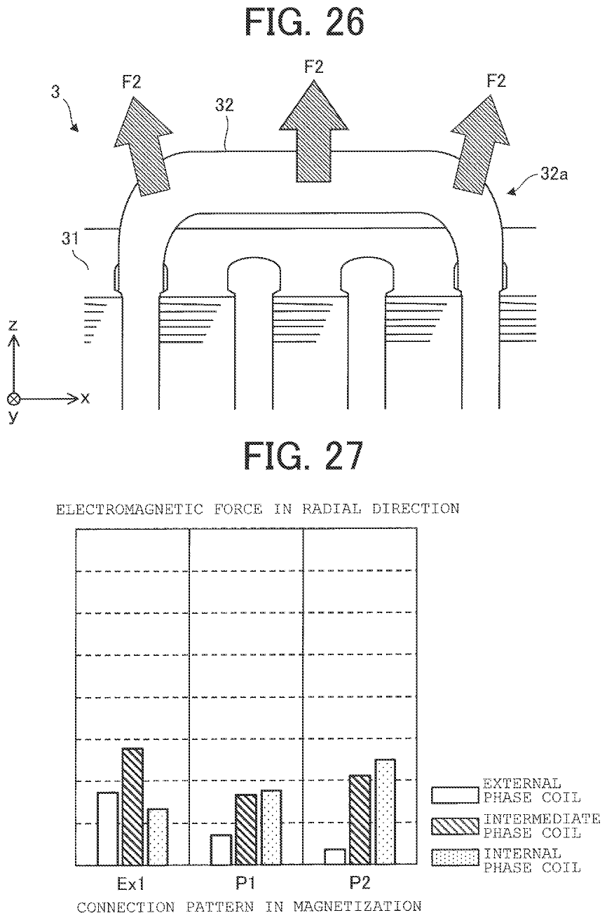

FIG. 26 is a diagram illustrating an example of electromagnetic forces F2 in a radial direction generated in the coil ends 32a of the three-phase coils 32 when the three-phase coils 32 are energized in the fabrication step of the stator 3, specifically, the magnetization step of the magnetic materials 22.

In a case where a current flows through a curved path such as the coil ends 32a, a difference in the magnetic flux density caused by a current occurs between the inner side and the outer side of the curved portion, and forces are generated in the three-phase coils 32 so as to uniformize the magnetic flux density. Accordingly, forces that are to deform the coil ends 32a linearly are generated in the coil ends 32a. Since the both end portions of the coil ends 32a in the coils of each phase are fixed to the stator core 31, forces are exerted in the axial direction in the coil ends 32a. Accordingly, when a current flows through the three-phase coils 32 from the source of electric power for magnetization, electromagnetic forces F2 in the axial direction are generated in the three-phase coils 32, as illustrated in FIG. 26.

FIG. 27 is a graph showing a difference in magnitude of an electromagnetic force F1 in the radial direction among connection patterns of the three-phase coils 32 when coils of each phase are energized in the magnetization step of the magnetic material 22. That is, FIG. 27 is a graph showing a difference in magnitude of the electromagnetic force F1 in the radial direction generated when magnetization is performed in three-phase electrification in the magnetization step of the magnetic material 22. Data shown in FIG. 27 is a result of analysis by an electromagnetic field analysis.

In FIG. 27, the connection patterns P1 and P2 correspond to connection patterns shown in FIGS. 7 and 15, respectively. A connection pattern Ex1 is a comparative example. In the connection pattern Ex1, in the three-phase coils 32 connected by Y connection, the external phase coils 323 are connected to the positive side of the source of electric power for magnetization, and the internal phase coils 321 and the intermediate phase coils 322 are connected to the negative side of the source of electric power. In the connection pattern Ex1, a large current flows through the external phase coils 323.

In the connection pattern Ex1, a large current flows through the external phase coils 323 from the source of electric power for magnetization, and electromagnetic forces F1 generated in the external phase coils 323 are larger than those in the connection patterns P1 and P2. In this case, the external phase coils 323 are easily deformed in the radial direction. Accordingly, when the electric motor 1 is applied to a compressor, for example, the external phase coils 323 approach a metal part (e.g., a closed container of the compressor), and it becomes difficult to obtain electrical insulation of the external phase coils 323.

On the other hand, in the connection patterns P1 and P2, electromagnetic forces F1 generated in the external phase coils 323 are smaller than those in the connection pattern Ex1. Thus, in performing magnetization with the rotor 2 disposed inside the stator 3, significant deformation of the three-phase coils 32, especially the external phase coils 323, can be prevented. As a result, deformation of the external phase coils 323 is suppressed, and thus electrical insulation of the external phase coils 323 can be obtained.

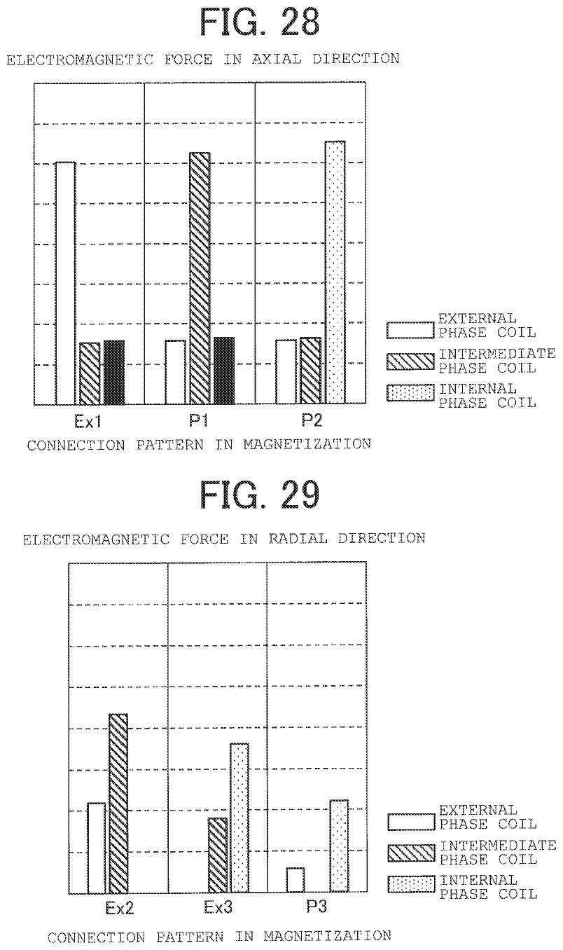

FIG. 28 is a graph showing a difference in magnitude of electromagnetic forces F2 in the axial direction among connection patterns pf the three-phase coils 32 when coils of each phase are energized in the magnetization step of the magnetic materials 22. That is, FIG. 28 is a graph showing a difference in magnitude of the electromagnetic forces F2 in the axial direction generated when magnetization is performed in three-phase electrification in the magnetization step of the magnetic material 22. In FIG. 28, the connection patterns Ex1, P1, and P2 correspond to the connection patterns Ex1, P1, and P2, respectively, in FIG. 27.

As shown in FIG. 28, with respect to electromagnetic forces F2 in the axial direction, a large electromagnetic force F2 in the axial direction is generated in one of the three-phase coils 32, independently of the connection pattern. Specifically, in the connection pattern Ex1, a large current flows through the external phase coils 323 from the source of electric power, and large electromagnetic forces F2 in the axial direction are generated in the external phase coils 323. In the connection pattern P1, a large current flows through the intermediate phase coils 322 from the source of electric power, and large electromagnetic forces F2 in the axial direction are generated in the intermediate phase coils 322. In the connection pattern P2, a large current flows through the internal phase coils 321 from the source of electric power, and large electromagnetic forces F2 in the axial direction are generated in the internal phase coils 321.

As described above, in the magnetization step of the magnetic material 22, the connection pattern of the three-phase coils 32 is preferably the connection pattern P1 or P2 in consideration of electromagnetic forces F1 in the radial direction. In the connection pattern P1 or P2, however, electromagnetic forces F2 of the first phase coils connected to the positive side of the source of electric power for magnetization are large. Deformation tends to be large especially in a center portion, that is, the first region 35a, of each first phase coil.

Thus, at each of the coil ends 32a of each first phase coil, the lacing material 34 is wound on the first region 35a more than the second region 35b and the third region 35c. In other words, at each of the coil ends 32a of each first phase coil, the density of the lacing material 34 in the first region 35a is higher than at least one of the density of the lacing material 34 in the second region 35b or the density of the lacing material 34 in the third region 35c. In the connection pattern P1, the first phase coils are the intermediate phase coils 322, and in the connection pattern P2, the first phase coils are the internal phase coils 321.

Accordingly, in the connection pattern P1 or P2, in performing magnetization with the rotor 2 disposed inside the stator 3, the lacing material 34 can prevent significant deformation of the first phase coils.

Accordingly, deformation of the three-phase coils 323 is suppressed, and thus, performance of the electric motor 1, for example, electrical insulation of the three-phase coils 32, can be obtained.

In addition, at each of the coil ends 32a of each first phase coil, the lacing material 34 only needs to be wound on the first region 35a more than at least one of the second region 35b or the third region 35c, and thus, the number of lacing materials 34 can be reduced, and costs for the stator 3 can be reduced. Accordingly, significant deformation of the three-phase coils 32 can be efficiently prevented.

The amount of the varnish 36 adhering to the lacing material 34 in the first region 35a only needs to be larger than at least one of the amount of varnish adhering to the lacing material 34 in the second region 35b or the amount of varnish adhering to the lacing material 34 in the third region 35c. Accordingly, holding power of the lacing material 34 in the first region 35a is enhanced. Consequently, the first phase coils can be firmly fixed, and the amount of varnish 36 in the stator 3 can be reduced, as compared to a conventional technique.

FIG. 29 is a graph showing a difference in magnitude of electromagnetic forces F1 in the radial direction among connection pattern of the three-phase coils 32 when two coils of the three-phase coils 32 are energized in the magnetization step of the magnetic material 22. That is, FIG. 29 is a graph showing a difference in magnitude of the electromagnetic force F1 in the radial direction generated when magnetization is performed in two-phase electrification in the magnetization step of the magnetic material 22. Data shown in FIG. 29 is a result of analysis by an electromagnetic field analysis.

In FIG. 29, the connection pattern P3 corresponds to the connection pattern shown in FIG. 18. Connection patterns Ex2 and Ex3 are comparative examples. In the connection pattern Ex2, in the three-phase coils 32 connected by Y connection, the external phase coils 323 are connected to the positive side of the source of electric power for magnetization, the intermediate phase coils 322 are connected to the negative side of the source of electric power, and one end of each internal phase coil 321 is an open end. In the connection pattern Ex3, in the three-phase coils 32 connected by Y connection, the intermediate phase coils 322 are connected to the positive side of the source of electric power for magnetization, the internal phase coils 321 are connected to the negative side of the source of electric power, and one end of each internal phase coil 321 is an open end.

In the connection pattern Ex2, a large current flows through the external phase coils 323 from the source of electric power for magnetization, and electromagnetic forces F1 generated in the external phase coils 323 are large. In this case, the external phase coils 323 are easily deformed in the radial direction. Accordingly, when the electric motor 1 is applied to a compressor, for example, the external phase coils 323 approach a metal part (e.g., a closed container of the compressor) and it becomes difficult to obtain electrical insulation of the external phase coils 323.

On the other hand, in the connection patterns Ex3 and P3, electromagnetic forces F1 generated in the external phase coils 323 are smaller than those in the connection pattern Ex2. Thus, in performing magnetization with the rotor 2 disposed inside the stator 3, significant deformation of the three-phase coils 32, especially the external phase coils 323, can be prevented. As a result, deformation of the external phase coils 323 is suppressed, and thus electrical insulation of the external phase coils 323 can be obtained.

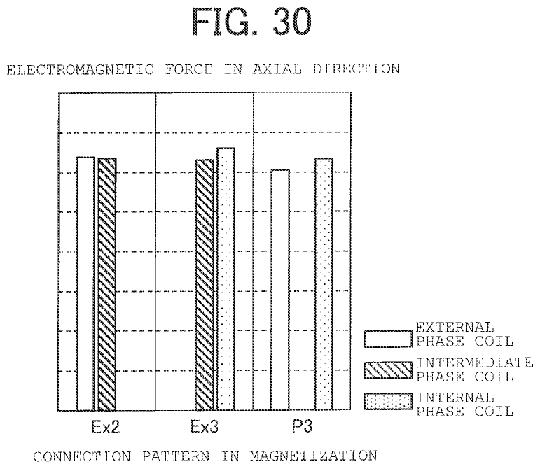

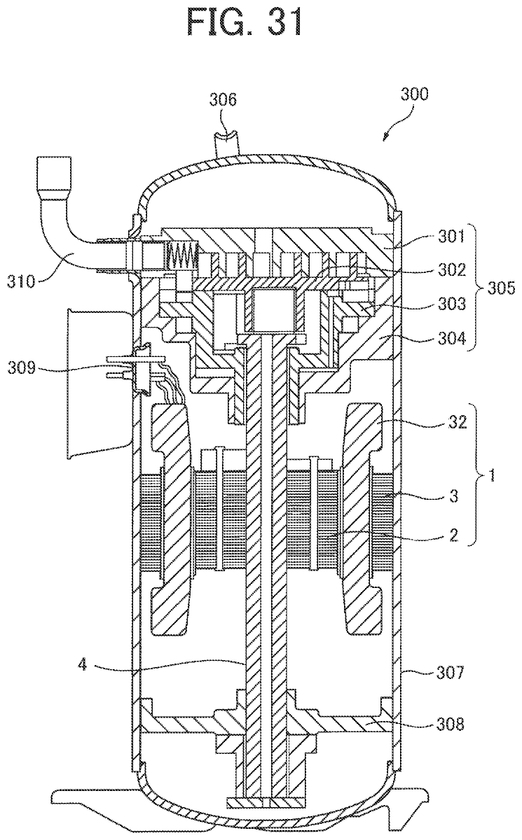

FIG. 30 is a graph showing a difference in magnitude of electromagnetic forces F2 in the axial direction among connection patterns of the three-phase coils 32 when two coils of the three-phase coils 32 are energized in the magnetization step of the magnetic material 22. That is, FIG. 30 is a graph showing a difference in magnitude of the electromagnetic forces F2 in the axial direction generated when magnetization is performed in two-phase electrification in the magnetization step of the magnetic material 22. In FIG. 30, the connection patterns Ex2, Ex3, and P3 correspond to the connection patterns Ex2, Ex3, and P3, respectively, in FIG. 29.

As shown in FIG. 30, with respect to electromagnetic forces F2 in the axial direction, a large electromagnetic force F2 in the axial direction is generated in two coils of the three-phase coils 32, independently of the connection pattern.

In the case of two-phase electrification, in the magnetization step of the magnetic material 22, the connection pattern of the three-phase coils 32 is preferably the connection pattern Ex3 or P3 in consideration of electromagnetic forces F1 in the radial direction. In the connection pattern Ex3, since electromagnetic forces F1 in the internal phase coils 321 are large, in the case of two-phase electrification, connection of the three-phase coils 32 is more preferably the connection pattern P3.

In the connection pattern Ex3 or P3, however, electromagnetic forces F2 of the first phase coils connected to the positive side of the source of electric power for magnetization are large. Deformation tends to be large especially in a center portion, that is, the first region 35a, of each first phase coil.

Thus, at each of the coil ends 32a of each first phase coil, the lacing material 34 is wound on the first region 35a more than the second region 35b and the third region 35c. In other words, at each of the coil ends 32a of each first phase coil, the density of the lacing material 34 in the first region 35a is higher than at least one of the density of the lacing material 34 in the second region 35b or the density of the lacing material 34 in the third region 35c. In the connection pattern Ex3, the first phase coils are the intermediate phase coils 322, and in the connection pattern P3, the first phase coils are the internal phase coils 321.

Accordingly, in the connection pattern Ex3 or P3, in performing magnetization with the rotor 2 disposed inside the stator 3, the lacing material 34 can prevent significant deformation of the first phase coils.

Accordingly, deformation of the three-phase coils 323 is suppressed, and thus, performance of the electric motor 1, for example, electrical insulation of the three-phase coils 32, can be obtained.

In addition, at each of the coil ends 32a of each first phase coil, the lacing material 34 only needs to be wound on the first region 35a more than at least one of the second region 35b or the third region 35c, and thus, the number of lacing materials 34 can be reduced, and costs for the stator 3 can be reduced. Accordingly, significant deformation of the three-phase coils 32 can be efficiently prevented.

The amount of the varnish 36 adhering to the lacing material 34 in the first region 35a only needs to be larger than at least one of the amount of varnish adhering to the lacing material 34 in the second region 35b or the amount of varnish adhering to the lacing material 34 in the third region 35c. Accordingly, holding power of the lacing material 34 in the first region 35a is enhanced. Consequently, the first phase coils can be firmly fixed, and the amount of varnish 36 in the stator 3 can be reduced, as compared to a conventional technique.

In a case where the three-phase coils 32 are connected by delta connection, properties shown in FIGS. 27 through 30 are also obtained. Thus, in the case where the three-phase coils 32 are connected by delta connection, in performing magnetization with the rotor 2 disposed inside the stator 3, the lacing material 34 can also prevent significant deformation of the first phase coils. Accordingly, deformation of the three-phase coils 323 is suppressed, and thus, performance of the electric motor 1, for example, electrical insulation of the three-phase coils 32, can be obtained.

In the case there the three-phase coils 32 are connected by delta connection, at each of the coil ends 32a of each first phase coil, the lacing material 34 also only needs to be wound on the first region 35a more than at least one of the second region 35b or the third region 35c. In this case, the number of lacing materials 34 can be reduced, and costs for the stator 3 can be reduced. Accordingly, significant deformation of the three-phase coils 32 can be efficiently prevented.

In the case where the three-phase coils 32 are connected by delta connection, the amount of the varnish 36 adhering to the lacing material 34 in the first region 35a also only needs to be larger than at least one of the amount of varnish adhering to the lacing material 34 in the second region 35b or the amount of varnish adhering to the lacing material 34 in the third region 35c. Accordingly, holding power of the lacing material 34 in the first region 35a is enhanced. Consequently, the first phase coils can be firmly fixed, and the amount of varnish 36 in the stator 3 can be reduced, as compared to a conventional technique.

### Second Embodiment

A compressor 300 according to a second embodiment of the present invention will be described.

FIG. 31 is a cross-sectional view schematically illustrating a structure of the compressor 300.

The compressor 300 includes an electric motor 1 as an electric element, a closed container 307 as a housing, and a compression mechanism 305 as a compression element (also referred to as a compression device). In this embodiment, the compressor 300 is a scroll compressor. The compressor 300 is not limited to the scroll compressor. The compressor 300 may be a compressor except for the scroll compressor, such as a rotary compressor.

The electric motor 1 in the compressor 300 is the electric motor 1 described in the first embodiment. The electric motor 1 drives the compression mechanism 305.

The compressor 300 includes a subframe 308 supporting a lower end (i.e., an end opposite to the compression mechanism 305) of a shaft 4.

The compression mechanism 305 is disposed inside the closed container 307. The compressor mechanism 305 includes a fixed scroll 301 having a spiral portion, a swing scroll 302 having a spiral portion forming a compression chamber between the spiral portion of the swing scroll 302 and the spiral portion of the fixed scroll 301, a compliance frame 303 holding an upper end of the shaft 4, and a guide frame 304 fixed to the closed container 307 and holding the compliance frame 303.

A suction pipe 310 penetrating the closed container 307 is press fitted in the fixed scroll 301. The closed container 307 is provided with a discharge pipe 306 that discharges a high-pressure refrigerant gas discharged from the fixed scroll 301, to the outside. The discharge pipe 306 communicates with an opening disposed between the compressor mechanism 305 of the closed container 307 and the electric motor 1.

The electric motor 1 is fixed to the closed container 307 by fitting the stator 3 in the closed container 307. The configuration of the electric motor 1 has been described above. To the closed container 307, a glass terminal 309 for supplying electric power to the electric motor 1 is fixed by welding.

When the electric motor 1 rotates, this rotation is transferred to the swing scroll 302, and the swing scroll 302 swings. When the swing scroll 302 swings, the volume of the compression chamber formed by the spiral portion of the swing scroll 302 and the spiral portion of the fixed scroll 301 changes. Then, a refrigerant gas is sucked from the suction pipe 310, compressed, and then discharged from the discharge pipe 306.

The compressor 300 includes the electric motor 1 described in the first embodiment, and thus, has advantages described in the first embodiment.

In addition, since the compressor 300 includes the electric motor 1 described in the first embodiment, performance of the compressor 300 can be improved.

### Third Embodiment

A refrigeration air conditioning apparatus 7 serving as an air conditioner and including the compressor 300 according to the second embodiment will be described.

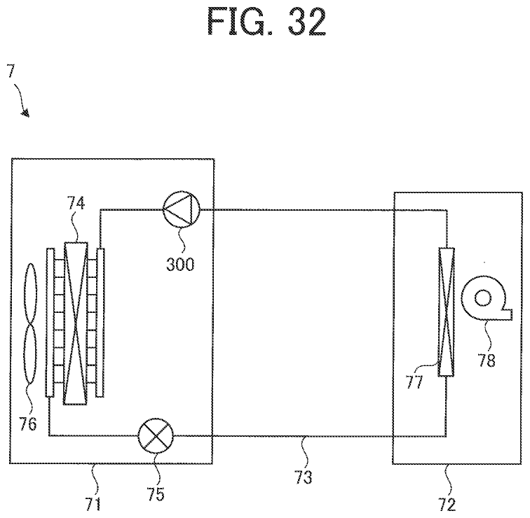

FIG. 32 is a diagram schematically illustrating a configuration of the refrigerating air conditioning device 7 according to the third embodiment.

The refrigeration air conditioning apparatus 7 is capable of performing cooling and heating operations, for example. A refrigerant circuit diagram illustrated in FIG. 32 is an example of a refrigerant circuit diagram of an air conditioner capable of performing a cooling operation.

The refrigeration air conditioning apparatus 7 according to the third embodiment includes an outdoor unit 71, an indoor unit 72, and a refrigerant pipe 73 connecting the outdoor unit 71 and the indoor unit 72 to each other.

The outdoor unit 71 includes a compressor 300, a condenser 74 as a heat exchanger, a throttling device 75, and an outdoor air blower 76 (first air blower). The condenser 74 condenses a refrigerant compressed by the compressor 300. The throttling device 75 decompresses the refrigerant condensed by the condenser 74 to thereby adjust a flow rate of the refrigerant. The throttling device 75 will be also referred to as a decompression device.

The indoor unit 72 includes an evaporator 77 as a heat exchanger, and an indoor air blower 78 (second air blower). The evaporator 77 evaporates the refrigerant decompressed by the throttling device 75 to thereby cool indoor air.

A basic operation of a cooling operation in the refrigeration air conditioning apparatus 7 will now be described. In the cooling operation, a refrigerant is compressed by the compressor 300 and the compressed refrigerant flows into the condenser 74. The condenser 74 condenses the refrigerant, and the condensed refrigerant flows into the throttling device 75. The throttling device 75 decompresses the refrigerant, and the decompressed refrigerant flows into the evaporator 77. In the evaporator 77, the refrigerant evaporates, and the refrigerant (specifically a refrigerant gas) flows into the compressor 300 of the outdoor unit 71 again. When the air is sent to the condenser 74 by the outdoor air blower 76, heat moves between the refrigerant and the air. Similarly, when the air is sent to the evaporator 77 by the indoor air blower 78, heat moves between the refrigerant and the air.

The configuration and operation of the refrigeration air conditioning apparatus 7 described above are examples, and the present invention is not limited to the examples described above.

The refrigeration air conditioning apparatus 7 according to the third embodiment has the advantages described in the first and second embodiments.

In addition, since the refrigeration air conditioning apparatus 7 according to the third embodiment includes the compressor 300 according to the second embodiment, performance of the refrigeration air conditioning apparatus 7 can be improved.

Features of the embodiments and features of the variations described above can be combined as appropriate.

1. A stator capable of magnetizing a magnetic material of a rotor, the stator comprising:
a stator core;
three-phase coils attached to the stator core by distributed winding, the three-phase coils including a first phase coil, a second phase coil, and a third phase coil; and
a lacing material wound on the three-phase coil, wherein
the first phase coil is a coil through which a largest current flows among the three-phase coils when a current flows through the three-phase coils from a source of electric power for magnetizing the magnetic material,
the first phase coil has a first region, a second region, and a third region that are divided equally in a coil end of the three-phase coils,
the first region is located between the second region and the third region, and
the lacing material is wound on the first region more than at least one of the second region or the third region.

2. The stator according to claim 1, wherein
in the coil end, the second phase coil, the first phase coil, and the third phase are arranged in this order in a circumferential direction of the stator core, and
in the coil end, the second phase coil, the first phase coil, and the third phase coil are arranged in this order from an inner side of the stator core in a radial direction of the stator core.

3. The stator according to claim 1, wherein
in the coil end, the first phase coil, the second phase coil, and the third phase are arranged in this order in a circumferential direction of the stator core, and
in the coil end, the first phase coil, the second phase coil, and the third phase coil are arranged in this order from an inner side of the stator core in a radial direction of the stator core.

4. The stator according to claim 1, wherein
the second phase coil has a first region, a second region, and a third region that are divided equally in the coil end of the three-phase coils,
the first region of the second phase coil is located between the second region of the second phase coil and the third region of the second phase coil,
the third phase coil has a first region, a second region, and a third region that are divided equally in the coil end of the three-phase coils,
the first region of the third phase coil is located between the second region of the third phase coil and the third region of the third phase coil,
the first phase coil is a coil through which a largest current flows among the three-phase coils when a current flows through the three-phase coils from the source of electric power for magnetizing the magnetic material, and
in the coil end of the three-phase coil, density of the lacing material in the first region of the first phase coil is higher than each of density of the lacing material in the first region of the second phase coil and density of the lacing material in the first region of the third phase coil.

5. The stator according to claim 1, wherein
in the coil end, the first phase coil, the third phase coil, and the second phase are arranged in this order in a circumferential direction of the stator core, and
in the coil end, the first phase coil, the third phase coil, and the second phase coil are arranged in this order from an inner side of the stator core in a radial direction of the stator core.

6. The stator according to claim 1, wherein
the second phase coil has a first region, a second region, and a third region that are divided equally in the coil end of the three-phase coils,
the first region of the second phase coil is located between the second region of the second phase coil and the third region of the second phase coil,
the third phase coil has a first region, a second region, and a third region that are divided equally in the coil end of the three-phase coils,
the first region of the third phase coil is located between the second region of the third phase coil and the third region of the third phase coil,
the first phase coil and the second phase coil are coils through which a largest current flows among the three-phase coils when a current flows through the three-phase coils from the source of electric power for magnetizing the magnetic material, and
density of the lacing material in the first region of the first phase coil is higher than density of the lacing material in the first region of the third phase coil, and density of the lacing material in the first region of the second phase coil is higher than density of the lacing material in the first region of the third phase coil.

7. The stator according to claim 1, wherein
in the coil end, the third phase coil, the second phase coil, and the first phase are arranged in this order in a circumferential direction of the stator core, and
in the coil end, the third phase coil, the second phase coil, and the first phase coil are arranged in this order from an inner side of the stator core in a radial direction of the stator core.

8. The stator according to claim 1, wherein
the second phase coil has a first region, a second region, and a third region that are divided equally in the coil end of the three-phase coils,
the first region of the second phase coil is located between the second region of the second phase coil and the third region of the second phase coil,
the third phase coil has a first region, a second region, and a third region that are divided equally in the coil end of the three-phase coils,
the first region of the third phase coil is located between the second region of the third phase coil and the third region of the third phase coil,
the first phase coil is a coil through which a largest current flows among the three-phase coils when a current flows through the three-phase coils from the source of electric power for magnetizing the magnetic material, and
in the coil end of the three-phase coil, density of the lacing material in the first region of the first phase coil is higher than each of density of the lacing material in the first region of the second phase coil and density of the lacing material in the first region of the third phase coil.

9. The stator according to claim 1, wherein the first phase coil, the second phase coil, and the third phase coil are connected by Y connection.

10. The stator according to claim 1,
wherein the first phase coil, the second phase coil, and the third phase coil are connected by delta connection.

11. An electric motor comprising:
the stator according to claim 1; and
the rotor disposed inside the stator.

12. A compressor comprising:
a closed container;
a compression device disposed in the closed container; and
the electric motor according to claim 11, to drive the compression device.

13. An air conditioner comprising:
the compressor according to claim 12; and
a heat exchanger.

14. A method for fabricating a stator, the stator including a stator core and three-phase coils attached to the stator core by distributed winding, the three-phase coils including a first phase coil, a second phase coil, and a third phase coil, the first phase coil having a first region, a second region, and a third region that are divided equally in a coil end of the three-phase coils, the first region being located between the second region and the third region, the method comprising:
attaching the three-phase coils to the stator core by distributed winding; and
winding a lacing material on the first region more than at least one of the second region or the third region in a coil end of the first phase coil.

15. A method for magnetizing a magnetic material of a rotor inside a stator, the stator including a stator core and three-phase coils, the three-phase coils being attached to the stator core by distributed winding and including a first phase coil, a second phase coil, and a third phase coil, the first phase coil having a first region, a second region, and a third region that are divided equally in a coil end of the three-phase coil, the first region being located between the second region and the third region, a lacing material being wound on the first region more than at least one of the second region or the third region in a coil end of the first phase coil, the method comprising:
disposing the rotor including the magnetic material inside the stator; and
supplying a current to the three-phase coils from a source of electric power for magnetizing the magnetic material so that a largest current flows through the first phase coil.

16. The stator according to claim 5, wherein
the second phase coil has a first region, a second region, and a third region that are divided equally in the coil end of the three-phase coils,
the first region of the second phase coil is located between the second region of the second phase coil and the third region of the second phase coil,
the third phase coil has a first region, a second region, and a third region that are divided equally in the coil end of the three-phase coils,
the first region of the third phase coil is located between the second region of the third phase coil and the third region of the third phase coil,
the first phase coil and the second phase coil are coils through which a largest current flows among the three-phase coils when a current flows through the three-phase coils from the source of electric power for magnetizing the magnetic material, and
density of the lacing material in the first region of the first phase coil is higher than density of the lacing material in the first region of the third phase coil, and density of the lacing material in the first region of the second phase coil is higher than density of the lacing material in the first region of the third phase coil.

17. The stator according to claim 7, wherein
the second phase coil has a first region, a second region, and a third region that are divided equally in the coil end of the three-phase coils,
the first region of the second phase coil is located between the second region of the second phase coil and the third region of the second phase coil,
the third phase coil has a first region, a second region, and a third region that are divided equally in the coil end of the three-phase coils,
the first region of the third phase coil is located between the second region of the third phase coil and the third region of the third phase coil,
the first phase coil is a coil through which a largest current flows among the three-phase coils when a current flows through the three-phase coils from the source of electric power for magnetizing the magnetic material, and
in the coil end of the three-phase coil, density of the lacing material in the first region of the first phase coil is higher than each of density of the lacing material in the first region of the second phase coil and density of the lacing material in the first region of the third phase coil.
